(19) United States
(12) Patent Application Publication
(10) Pub. No.: US 2024/0391360 A1
(43) Pub. Date: Nov. 28, 2024

(54) VEHICLE SEAT REPOSITIONING

(71) Applicant: MULLEN TECHNOLOGIES, INC., Brea, CA (US)

(72) Inventors: Kedar Deshmukh, Irvine, CA (US); Robert Huotari, Irvine, CA (US); Marc Papakyriakou, Irvine, CA (US)

(21) Appl. No.: 18/369,820

(22) Filed: Sep. 18, 2023

Related U.S. Application Data
(60) Provisional application No. 63/468,135, filed on May 22, 2023.

(51) Int. Cl. B60N 2/02; B60N 2/00

(52) U.S. Cl. CPC B60N 2/0256; B60N 2/0021

(57) ABSTRACT

Systems, methods, and computer-readable media for repositioning vehicle seats are provided.

### CROSS REFERENCE TO RELATED APPLICATION(S)

This application claims the benefit of prior filed U.S. Provisional Patent Application No. 63/468,135, filed May 22, 2023, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever. whatsoever.

### TECHNICAL FIELD

This disclosure relates to vehicle seat repositioning and, more particularly, to vehicle seat repositioning based on passenger location.

### BACKGROUND OF THE DISCLOSURE

Many passenger vehicles have visual display screens towards the front of the vehicle that may be obstructed from view by rear seat passengers by one or more front seats. However, such front seats are often limited in their ability to be repositioned.

### SUMMARY OF THE DISCLOSURE

This document describes systems, methods, and computer-readable media for repositioning vehicle seats.

For example, a system is provided for vehicle seat repositioning, as disclosed herein.

As another example, a method is provided for vehicle seat repositioning, as disclosed herein.

As yet another example, a non-transitory computer-readable storage medium storing at least one program including instructions is provided, which, when executed, repositions a vehicle seat, as disclosed herein.

As yet another example, a vehicle is provided that includes a seat, an adjustable vehicle entity, and an entity adjustment management system including a passenger presence detection subsystem operative to determine an occupancy state of the seat, a vehicle information subsystem including a user input component, and an entity adjusting actuator subsystem operative to adjust the adjustable vehicle entity, wherein the entity adjustment management system is configured to enable automatically, based on the passenger presence detection subsystem determining that the seat is vacant, the user input component of the vehicle information subsystem to control electronically the entity adjusting actuator subsystem to adjust the adjustable vehicle entity.

As yet another example, a method for using a vehicle is provided that may include detecting a vacancy state of a seat of the vehicle and automatically enabling, based on the detecting the vacancy state of the seat, a user input component of a vehicle information subsystem of the vehicle to control electronically an actuator for adjusting an adjustable entity of the vehicle.

As yet another example, a non-transitory computer-readable storage medium storing at least one program is provided, the at least one program including instructions, which, when executed by at least one processor of an entity adjustment management system of a vehicle including a seat and an adjustable vehicle entity and a user input component, cause the at least one processor to detect a vacancy state of the seat of the vehicle and, in response to detection of the vacancy state, automatically enable the user input component to adjust electronically the adjustable vehicle entity.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide a vehicle management service in accordance with some embodiments of the disclosure;

FIG. 1A is a more detailed schematic view of a subsystem of the system of FIG. 1, in accordance with some embodiments of the disclosure;

FIG. 1B is a more detailed schematic view of a portion of the system of FIG. 1, in accordance with some embodiments of the disclosure;

FIG. 1C is a more detailed schematic view of another portion of the system of FIG. 1, in accordance with some embodiments of the disclosure;

FIG. 2 is a top, rear, right side perspective view of a vehicle with a seat repositioning system, in accordance with some embodiments of the disclosure;

FIG. 2A is a top, front, left side perspective view of a portion of the vehicle of FIG. 2, in accordance with some embodiments of the disclosure;

FIG. 2B is a rear interior view of a portion of the vehicle of FIGS. 2 and 2A, taken from line IIB-IIB of FIG. 2A, in accordance with some embodiments of the disclosure;

FIG. 2C is a top, rear, left side perspective view of a portion of the vehicle of FIGS. 2, 2A, and 2B, in accordance with some embodiments of the disclosure;

FIG. 2D is a front interior view of a portion of the vehicle of FIGS. 2 and 2A-2C, taken from line IID-IID of FIG. 2A, in accordance with some embodiments of the disclosure;

FIG. 2E is a right side interior view of a portion of the vehicle of FIGS. 2 and 2A-2D, taken from line IIE-IIE of FIG. 2A, in accordance with some embodiments of the disclosure;

FIG. 2F is a rear interior view of a portion of the vehicle of FIGS. 2 and 2A-2E, taken from line IIF-IIF of FIG. 2A, in accordance with some embodiments of the disclosure;

FIG. 2G is a left side interior view of a portion of the vehicle of FIGS. 2 and 2A-2F, taken from line IIG-IIG of FIG. 2A, in accordance with some embodiments of the disclosure;

FIG. 2H is a top view of a portion of the vehicle of FIGS. 2 and 2A-2G, in accordance with some embodiments of the disclosure;

FIG. 2I is a top, rear, right side perspective view of a portion of the vehicle of FIGS. 2 and 2A-2H, in accordance with some embodiments of the disclosure;

FIG. 2J is a top, rear, left side perspective view of a portion of the vehicle of FIGS. 2 and 2A-2I, in accordance with some embodiments of the disclosure;

FIG. 2K is a top, rear, right side perspective view of a portion of the vehicle of FIGS. 2 and 2A-2J, in accordance with some embodiments of the disclosure;

FIG. 2L is a top, front, right side perspective view of a portion of the vehicle of FIGS. 2 and 2A-2K, in accordance with some embodiments of the disclosure;

FIG. 2M is a perspective view of a portion of the vehicle of FIGS. 2 and 2A-2L, in accordance with some embodiments of the disclosure;

FIGS. 2N-2P are front views of screens of a graphical user interface of a subsystem of the vehicle of FIGS. 2 and 2A-2M, in accordance with some embodiments of the disclosure; and

FIG. 3 illustrates a flowchart of an exemplary process for adjusting an entity of a vehicle, in accordance with some embodiments of the disclosure.

### DETAILED DESCRIPTION OF THE DISCLOSURE

Systems, methods, and computer-readable media for repositioning vehicle seats are provided.

An objective is to provide various opportunities for one or more seats or other component(s) of a vehicle (e.g., front seat(s)) to be repositioned (e.g., to improve sight lines between a rear seat passenger and a visual display of the vehicle). A vehicle may be provided with any suitable vehicle seat repositioning management system for satisfying such an objective. In some embodiments, a front vehicle seat may be repositioned by a fixed controller accessible to a rear seat passenger of the vehicle (e.g., by a user interface (e.g., provided by a rear center console or armrest or rear passenger door or the like of the vehicle)). In some other embodiments, a front vehicle seat may be repositioned by a portable controller accessible to a rear seat passenger (e.g., by a user interface provided by a portable media device controlled by a rear seat passenger and temporarily communicatively coupled to another controller of the vehicle). In yet some other embodiments, a front vehicle seat may be repositioned by any other suitable controller accessible to a rear seat passenger (e.g., by any suitable voice commands and/or physical gestures that may be generated by a rear seat passenger). In some embodiments, the vehicle may be configured to allow such control only when certain conditions are determined to be satisfied (e.g., safety conditions, such as the front seat(s) not being occupied (e.g., as may be determined by an occupation classification system), the vehicle not moving (e.g., as may be determined by a vehicle speedometer), and/or the like).

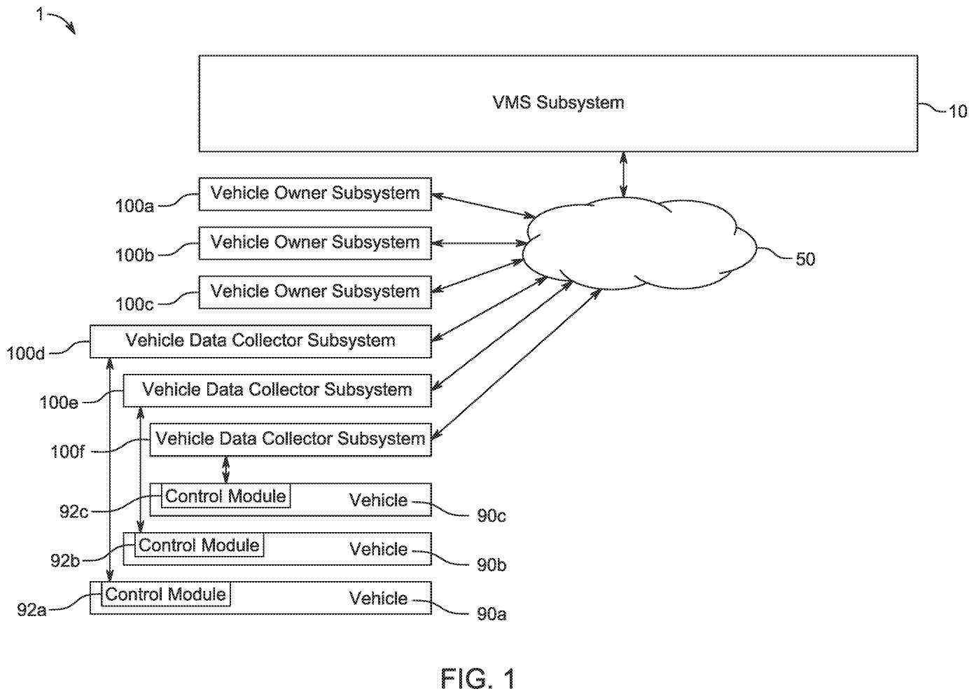

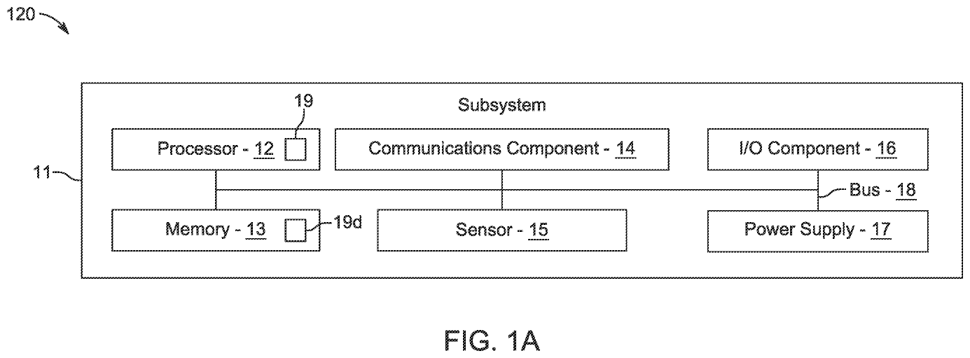

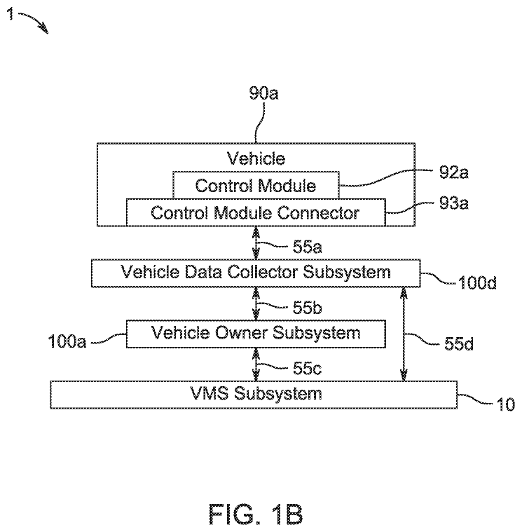

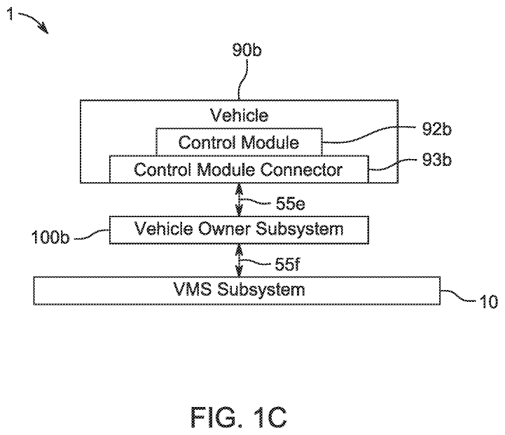

FIG. 1 is a schematic view of an illustrative system 1 in which a vehicle management service, including, but not limited to vehicle seat repositioning management, may be facilitated amongst one or more various entities. For example, as shown in FIG. 1, system 1 may include a vehicle management service (“VMS”) subsystem 10, various subsystems 100 (e.g., one or more vehicle owner (“VO”) subsystems 100a-100c, one or more vehicle data collector (“VDC”) subsystems 100d-100f, each of which may be communicatively coupled to one or more control modules (“CMs”) 92 of a respective vehicle 90 (e.g., CMs 92a-92c of respective vehicles 90a-90c that may be owned or operated or managed or controlled by passengers or owners of respective vehicle owner subsystems 100a-100c), and at least one communications network 50 through which any two or more of the subsystems 10 and 100 may communicate. VMS subsystem 10 may be operative to interact with any of the various subsystems 100 to provide a vehicle management service platform (“VMSP”) that may facilitate various vehicle management services, including, but not limited to, managing and enhancing the vehicle ownership process for vehicle buyers, vehicle users, and vehicle sellers for enabling effective and efficient vehicle transactions.

As shown in FIG. 1A, and as described in more detail below, a subsystem 120, which may be any of subsystems 10, 100, and/or modules 92, may include a processor component 12, a memory component 13, a communications component 14, a sensor component 15, an input/output (“I/O”) component 16, a power supply component 17, and/or a bus 18 that may provide one or more wired or wireless communication links or paths for transferring data and/or power to, from, or between various other components of subsystem 120. In some embodiments, one or more components of subsystem 120 may be combined or omitted. Moreover, subsystem 120 may include other components not combined or included in FIG. 1A and/or several instances of the components shown in FIG. 1A. For the sake of simplicity, only one of each of the components of subsystem 120 is shown in FIG. 1A. I/O component 16 may include at least one input component (e.g., button, mouse, keyboard, etc.) to receive information from a user or other device or power therefrom and/or at least one output component (e.g., audio speaker, video display, haptic component, etc.) to provide information or power or any other suitable support to a user or other device, such as a touch screen that may receive input information through a user's touch of a display screen and that may also provide visual information to a user via that same display screen, or an airbag that may be deployed to provide security to one or more passengers of a vehicle user, or a vehicle seat repositioning management system that may be used to control and carry out the movement of one or more vehicle seats or other components (e.g., motors, controllers, gears, etc.), and/or the like. In some embodiments, an I/O component 16 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like. Memory 13 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., data 19d)). Communications component 14 may be provided to allow subsystem 120 to communicate with one or more other subsystems 120 (e.g., any communication to/from/between subsystem(s)/module(s) 10, 100, and 92 of system 1) using any suitable communications protocol. Communications component 14 can be operative to create or connect to a communication network or link of a network. Communications component 14 can provide wireless communications using any suitable short-range or long-range communications protocol, such as Wi-Fi (e.g., an 802.11 protocol), Bluetooth, ultra-wideband, radio frequency systems (e.g., 1200 MHz, 2.4 GHz, and 5.6 GHz communication systems), near field communication (“NFC”), infrared, protocols used by wireless and cellular telephones and personal e-mail devices, or any other protocol supporting wireless communications. Communications component 14 can also be operative to connect to a wired communications link or directly to another data source wirelessly or via one or more wired connections or other suitable connection type(s). Communications component 14 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 15 may be any suitable sensor that may be configured to sense any suitable data for subsystem 120 (e.g., location-based data via a GPS sensor system, motion data, environmental data, biometric data, etc.). Sensor 15 may be a sensor assembly that may include any suitable sensor or any suitable combination of sensors operative to detect movements of subsystem 120 and/or of any user thereof and/or any other characteristics of subsystem 120 and/or of its environment (e.g., physical activity or other characteristics of a user of subsystem 120, light content of the device environment, gas pollution content of the device environment, noise pollution content of the device environment, altitude of the device, etc.). Sensor 15 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 15 may include any suitable sensor components or subassemblies for detecting any suitable movement of subsystem 120 and/or of a user thereof. For example, sensor 15 may include one or more three-axis acceleration motion sensors (e.g., an accelerometer) that may be operative to detect linear acceleration in three directions (i.e., the x- or left/right direction, the y- or up/down direction, and the z- or forward/backward direction). As another example, sensor 15 may include one or more single-axis or two-axis acceleration motion sensors that may be operative to detect linear acceleration only along each of the x- or left/right direction and the y- or up/down direction, or along any other pair of directions. In some embodiments, sensor 15 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 15 may be operative to directly or indirectly detect rotation, rotational movement, angular displacement, tilt, position, orientation, motion along a non-linear (e.g., arcuate) path, or any other non-linear motions. Additionally or alternatively, sensor 15 may include one or more angular rate, inertial, and/or gyro-motion sensors or gyroscopes for detecting rotational movement. For example, sensor 15 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 15 for detecting motion on subsystem 120, such as any suitable pressure sensors, altimeters, or the like. Using sensor 15, subsystem 120 may be configured to determine a velocity, acceleration, orientation, and/or any other suitable motion attribute of subsystem 120 (e.g., a direction and/or strength of an impact (e.g., a crash involving a vehicle 90). One or more biometric sensors may be multi-modal biometric sensors and/or operative to detect long-lived biometrics, modern liveness (e.g., active, passive, etc.) biometric detection, and/or the like. Sensor 15 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature-processing application that may be accessible to subsystem 120 for attempting to authenticate a user), line-in connector for data and/or power, and/or combinations thereof. In some examples, each sensor can be a separate device, while, in other examples, any combination of two or more of the sensors can be included within a single subsystem or device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single subsystem or device. Subsystem 120 can further include a timer that can be used, for example, to add time dimensions to various attributes of any detected element(s). Sensor 15 may include any suitable sensor components or subassemblies for detecting any suitable characteristics of any suitable condition of the lighting of the environment of subsystem 120. For example, sensor 15 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 120 (e.g., in lux or lumens per square meter, etc.) and/or for determining the ambient color or white point chromaticity of ambient light in the environment of subsystem 120 (e.g., in hue and colorfulness or in x/y parameters with respect to an x-y chromaticity space, etc.) and/or for determining the UV index or UV radiation in the environment of subsystem 120 (e.g., in UV index units, etc.). Sensor 15 may include any suitable sensor components or subassemblies for detecting any suitable characteristics of any suitable condition of the air quality of the environment of subsystem 120. For example, sensor 15 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 120 (e.g., in O₂% per liter, etc.) and/or for determining the air velocity of the ambient air in the environment of subsystem 120 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of subsystem 120 (e.g., in HG % per liter, etc.) and/or for determining the humidity of the ambient air in the environment of subsystem 120 (e.g., in grams of water per cubic meter, etc. (e.g., using a hygrometer)) and/or for determining the temperature of the ambient air in the environment of subsystem 120 (e.g., in degrees Celsius, etc. (e.g., using a thermometer)). Sensor 15 may include any suitable sensor components or subassemblies for detecting any suitable characteristics of any suitable condition of the sound quality of the environment of subsystem 120. For example, sensor 15 may include any suitable sound quality sensor that may include, but is not limited to, one or more microphones or the like that may determine the level of sound pollution or noise in the environment of subsystem 120 (e.g., in decibels, etc.). Sensor 15 may also include any other suitable sensor for determining any other suitable characteristics about a user of subsystem 120 and/or the environment of subsystem 120 and/or any situation within which subsystem 120 may exist. For example, any suitable clock and/or position sensor(s) may be provided to determine the current time and/or time zone within which subsystem 120 may be located. Sensor 15 may be embedded in a body (e.g., housing 11) of subsystem 120, such as along a bottom surface that may be operative to contact a user, or can be positioned at any other desirable location. In some examples, different sensors can be placed in different locations inside or on the surfaces of subsystem 120 (e.g., some located inside housing 11 (e.g., any suitable component of a vehicle) and some attached to an attachment mechanism (e.g., a wrist band coupled to a housing of a wearable device), or the like). In other examples, one or more sensors can be worn by a user separately as different parts of a single subsystem 120 or as different subsystems or devices. In such cases, the sensors can be configured to communicate with subsystem 120 using a wired and/or wireless technology (e.g., via communications component 14). In some examples, sensors can be configured to communicate with each other and/or share data collected from one or more sensors.

Power supply 17 can include any suitable circuitry for receiving and/or generating power, and for providing such power to one or more of the other components of subsystem 120. For example, power supply assembly 17 can be coupled to a power grid (e.g., when subsystem 120 is not acting as a portable device or when a battery of the device is being charged at an electrical outlet with power generated by an electrical power plant). As another example, power supply assembly 17 may be configured to generate power from a natural source (e.g., solar power using solar cells). As another example, power supply assembly 17 can include one or more batteries for providing power (e.g., when subsystem 120 is acting as a portable device). Subsystem 120 may also be provided with a housing 11 that may at least partially enclose one or more of the components of subsystem 120 for protection from debris and other degrading forces external to subsystem 120. Each component of subsystem 120 may be included in the same housing 11 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 120 may include other components not combined or included in those shown or several instances of the components shown.

Processor 12 may be used to run one or more applications, such as an application 19 that may be accessible from memory 13 (e.g., as a portion of data 19d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem), application programming interfaces (“APIs”), software development kits (“SDKs”), proprietary applications (e.g., a web application or a native application) for enabling subsystem 120 to interact with an online service and/or one or more other subsystems and/or the like, which may include applications for routing protocols, SDN modules based on OpenFlow, P4, or other network data plane programming standards, machine learning algorithms, network management functions, etc., any other suitable applications, such as applications for detecting and reacting to impact on a vehicle and/or detecting and reacting to and/or adjusting the positioning of travelers and components (e.g., seats, sun roof, etc.) of and within a vehicle (e.g., to adjust the position of any vehicle feature (e.g., sunroof or seat or passenger or vehicle seat) and/or deploy an airbag or the like), applications for detecting and reacting to communicative coupling to/decoupling from any suitable portable media device, applications for detecting and reacting to certain vehicle conditions (e.g., safety conditions, such as the front seat(s) not being occupied (e.g., as may be determined by an occupation classification system), the vehicle not moving (e.g., as may be determined by a vehicle speedometer), and/or the like), and/or the like. For example, processor 12 may load an application 19 as an interface program to determine how instructions or data received via an input component of I/O component 16 or other component of subsystem 120 (e.g., sensor 15 and/or communications component 14) may manipulate the way in which information may be stored (e.g., in memory 13) and/or provided via an output component of I/O component 16 and/or communicated to another system device via communications component 14. As one example, application 19 may be a third party application that may be running on subsystem 120 (e.g., an application associated with the network of system 1) that may be loaded on subsystem 120 in any suitable manner, such as via an application market (e.g., using communications component 14), such as the Apple App Store or Google Play, or that may be accessed via an internet application or web browser (e.g., by Apple Safari or Google Chrome) that may be running on subsystem 120 and that may be pointed to a uniform resource locator (“URL”) whose target or web resource may be managed by or otherwise affiliated with any suitable entity. Any subsystem may include any suitable special purpose hardware (e.g., hardware support of high-speed packet processing, hardware support of machine learning algorithms, etc.).

Subsystem 120 may be any portable, mobile, wearable, implantable, or hand-held electronic device configured to operate with system 1. Alternatively, subsystem 120 may not be portable during use, but may instead be generally stationary (e.g., permanently coupled to a vehicle or in a server center or the like). Subsystem 120 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device, boom box, modem, router, printer, kiosk, beacon, server, vehicle seat repositioning management system, and any combinations thereof.

In some embodiments, processor 12 may be used to run one or more applications that may be accessible from memory 13 and/or from any other suitable source (e.g., an application from VMS subsystem 10 via an active internet connection or otherwise at and for use by a subsystem 100). Such an application may include, but is not limited to, one or more operating system applications, firmware applications, communication applications, internet browsing applications (e.g., for interacting with a website provided by VMS subsystem 10 for enabling a subsystem 100 to interact with an online service of VMS subsystem 10 (e.g., a VMSP)), VMS applications (e.g., a web application or a native application or a hybrid application that may be at least partially produced by VMS subsystem 10 for enabling a subsystem 100 to interact with an online service of VMS subsystem 10 (e.g., a VMSP)), or any other suitable applications. As one example, an application of a subsystem 100 may provide a user or a communicatively coupled device (e.g., control module 92) with the ability to interact with a vehicle management service or the VMSP of VMS subsystem 10, where such an application may be a third party application that may be running on a subsystem 100 (e.g., an application (e.g., software and/or firmware) associated with VMS subsystem 10 that may be loaded on subsystem 100 from VMS subsystem 10 or via an application market) and/or that may be accessed via an internet application or web browser running on subsystem 100 (e.g., processor 12) that may be pointed to a uniform resource locator (“URL”) whose target or web resource may be managed by VMS subsystem 10 or any other remote subsystem. Each subsystem 100 may be a portable media device (e.g., a smartphone), a laptop computer, a tablet computer, a desktop computer, an appliance, a wearable electronic device, a virtual reality device, a dongle device, at least one web or network server (e.g., for providing an online resource, such as a website or native online application, for presentation on one or more other subsystems) with an interface for an administrator of such a server, and/or the like.

Some or all portions of VMS subsystem 10 may be operated, managed, or otherwise at least partially controlled by an entity (e.g., administrator) responsible for providing a vehicle management service to one or more clients or other suitable entities. VMS subsystem 10 may communicate with one or more subsystems 100 via communications network 50. Network 50 may be the internet or any other suitable network, such that when intercoupled via network 50, any two subsystems of system 1 may be operative to communicate with one another (e.g., a subsystem 100 may access information (e.g., from an application 19 or data 19d of VMS subsystem 10, as may be provided as a vehicle management service via processor 12 and communications component 14 of VMS subsystem 10) as if such information were stored locally at that subsystem 100 (e.g., in its memory component 13)).

Various clients and/or partners may be enabled to interact with VMS subsystem 10 for enabling the vehicle management services and the VMSP. For example, at least one vehicle owner subsystem of system 1 (e.g., each one of the one or more vehicle owner subsystems 100a-100c) may be any suitable subsystem (e.g., portable computer and/or infotainment or other suitable device that may be fixed or removably coupled to a vehicle for use by its passenger(s)) operated by any suitable vehicle owner (“VO”) that may own, rent, or otherwise have access to a vehicle (e.g., a respective one of the one or more vehicles 90a-90c (e.g., any suitable motor vehicle (e.g., car, truck, bus, motorcycle, etc.), railed vehicle (e.g., train, tram, etc.), watercraft (e.g., ship, boat, jet ski, etc.), aircraft (e.g., airplane, helicopter, drone, etc.), spacecraft, and/or the like)). At least one vehicle data collector subsystem of system 1 (e.g., each one of the one or more vehicle data collector subsystems 100d-100f) may be any suitable subsystem (e.g., dongle device) that may be communicatively coupled to a respective vehicle owner subsystem (e.g., via a network 50) and to a respective control module (e.g., via direct installation) of a respective vehicle (e.g., VDC subsystem 100d may be communicatively coupled to VO subsystem 100a and to CM 92a of vehicle 90a that may be owned by the operator of VO subsystem 100a, VDC subsystem 100e may be communicatively coupled to VO subsystem 100b and to CM 92b of vehicle 90b that may be owned by the operator of VO subsystem 100b, and VDC subsystem 100f may be communicatively coupled to VO subsystem 100c and to CM 92c of vehicle 90c that may be owned by the operator of VO subsystem 100c). For example, a VDC subsystem may be any suitable on-board diagnostics (“OBD”) device that may be operative to be communicatively coupled with any suitable control module of any suitable vehicle (e.g., via any suitable OBD-II data link connector of a vehicle (e.g., via a physical connection or wireless path)) that may be operative to monitor any suitable data from an engine control unit and/or electronic control unit (“ECU”) of the vehicle and/or from any other data source of the vehicle that may be made available (e.g., according to the OBD protocol), such as a powertrain control module (“PCM”) or otherwise. A VDC subsystem may be operative to send one or more requests to the CM of a vehicle for one or more specific parameters using one or more specific parameter identification numbers (“PIDs”) (e.g., according to the Society of Automotive Engineers (“SAE”) standard J1979) and then the VDC subsystem may communicate any received parameter data from the vehicle to a VO subsystem that may be communicatively coupled to the VDC subsystem (e.g., via any suitable wired or wireless communication protocol). For example, as shown in FIG. 1B, VDC subsystem 100d may be communicatively coupled to any suitable control module connector 93a via any suitable communications path 55a, which may be a direct physical connection between connector 93a and a connector of VDC subsystem 100d (e.g., a male connector of an I/O component 16 of VDC subsystem 100d may physically mate with a female control module connector 93a (e.g., any suitable OBD-II data link connector)), where control module connector 93a may be communicatively coupled to one, some, or all suitable control modules or data sources (e.g., control module 92a) of vehicle 90a, while VDC subsystem 100d may be communicatively coupled to VO subsystem 100a via any suitable communications path 55b (e.g., any suitable wired or wireless communications path using any suitable communications protocol (e.g., Bluetooth between a communications component 14 of VDC subsystem 100d and a communications component 14 of VO subsystem 100a), while VO subsystem 100a may be communicatively coupled to VMS subsystem 10 via any suitable communications path 55c (e.g., any suitable wired or wireless communications path (e.g., of network 50 of FIG. 1) using any suitable communications protocol). Alternatively or additionally, as shown in FIG. 1B, VDC subsystem 100d may be communicatively coupled to VMS subsystem 10 via any suitable communications path 55d (e.g., any suitable wired or wireless communications path (e.g., of network 50 of FIG. 1) using any suitable communications protocol (e.g., any suitable long-range communications protocol between a communications component 14 of VDC subsystem 100d and a communications component 14 of VMS subsystem 10 (e.g., using a low power communications component and/or any suitable telemetry functionality)) without VO subsystem 100a as an intermediary. Additionally or alternatively, in some embodiments, a VO subsystem may be configured to communicate directly with a CM of a vehicle without the need for a distinct intermediary VDC subsystem. For example, as shown in FIG. 1C, VO subsystem 100b may be communicatively coupled to any suitable control module connector 93b via any suitable communications path 55e, which may be a direct wired connection between connector 93b and a connector of VO subsystem 100b (e.g., a connector of an I/O component 116 of VO subsystem 100b may be communicatively coupled to a first connector of a cable of communications path 55e and a second connector of such a cable may be communicatively coupled with control module connector 93b (e.g., any suitable OBD-II data link connector)), where control module connector 93b may be communicatively coupled to one, some, or all suitable control modules or data sources (e.g., control module 92b) of vehicle 90b, while VO subsystem 100b may be communicatively coupled to VMS subsystem 10 via any suitable communications path 55f (e.g., any suitable wired or wireless communications path (e.g., of network 50 of FIG. 1) using any suitable communications protocol). In some embodiments, communications path 55e may be a wireless communications path between control module 92b and VO subsystem 100b (e.g., a wireless (e.g., Bluetooth) communication path between a communications component 14 of VO subsystem 100b and a communications component of control module 92b of vehicle 90b), such that a data connection may be facilitated directly between a user's portable electronic device and a computer of a vehicle directly through a wireless connection.

Each subsystem 100 of system 1 (e.g., each one of subsystems 100a-100f) may be operated by any suitable entity for interacting in any suitable way with VMS subsystem 10 (e.g., via network 50) for deriving value from and/or adding value to a service of the VMSP of VMS subsystem 10. For example, a particular subsystem 100 may be a server operated by a client/partner entity that may receive any suitable data from VMS subsystem 10 related to any suitable vehicle management enhancement of the VMSP provided by VMS subsystem 10 (e.g., via network 50). Additionally or alternatively, a particular subsystem 100 may be a server operated by a client/partner entity that may upload or otherwise provide any suitable data to VMS subsystem 10 related to any suitable vehicle management service of the VMSP provided by VMS subsystem 10 (e.g., via network 50).

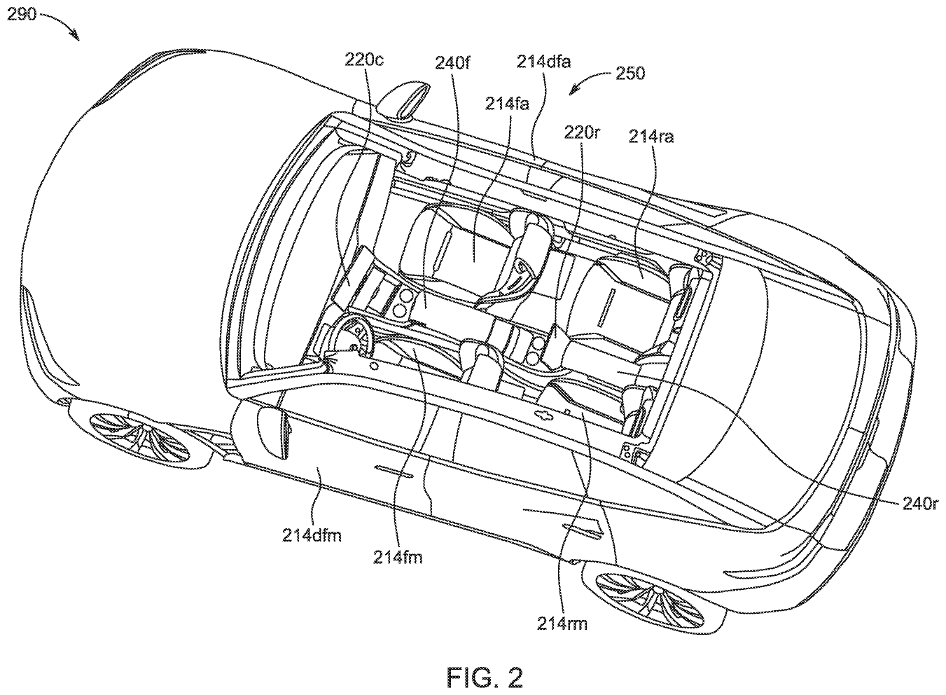

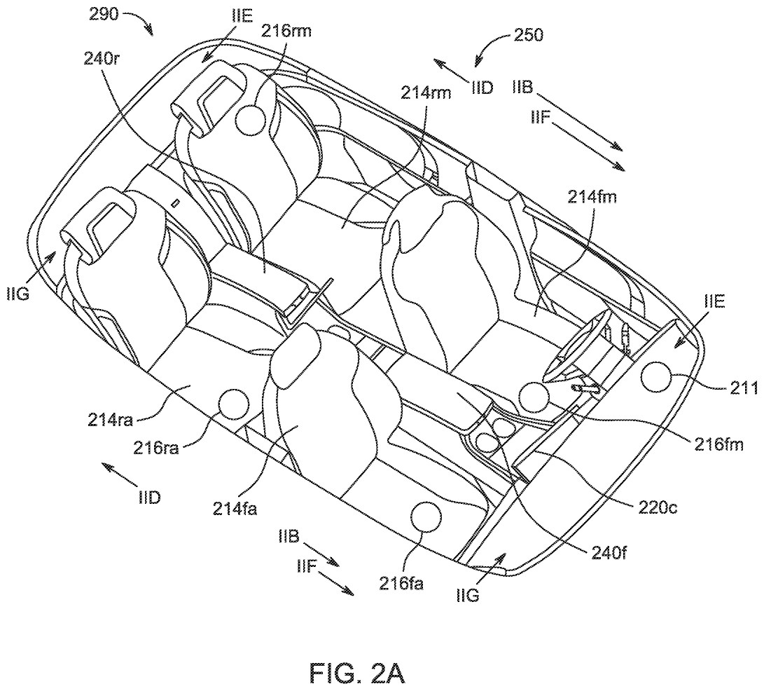

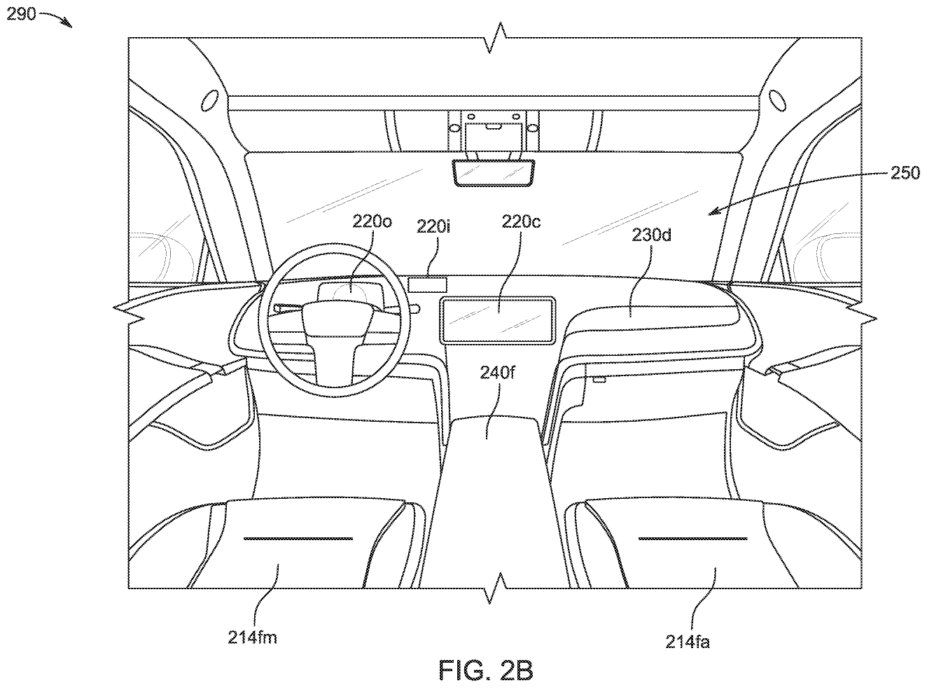

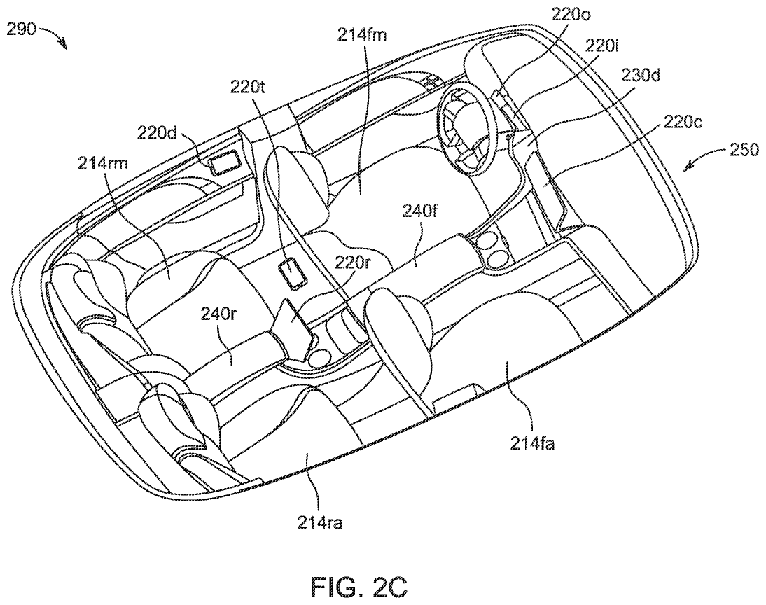

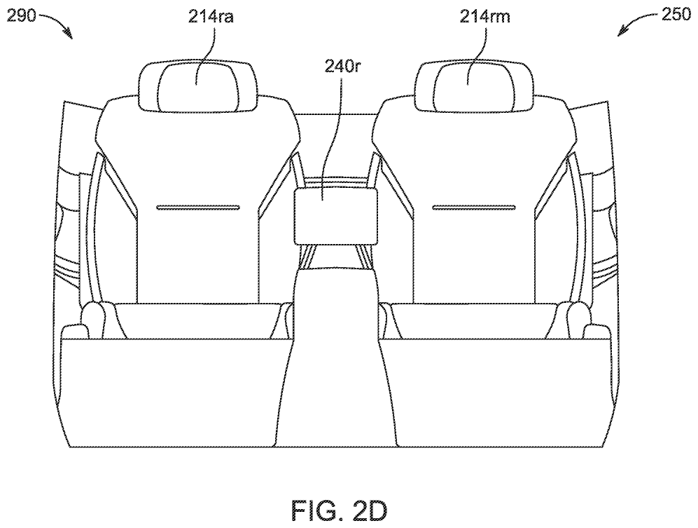

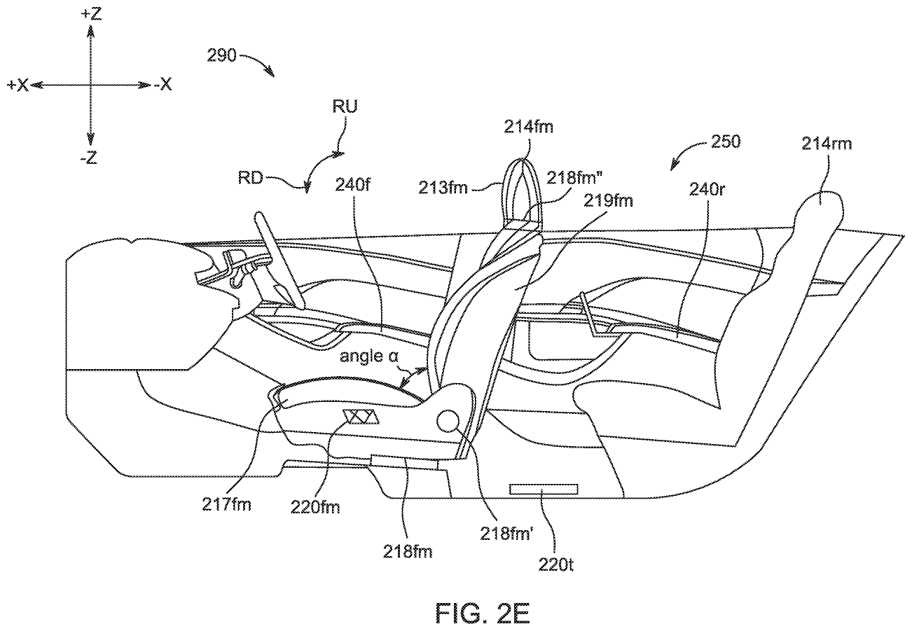

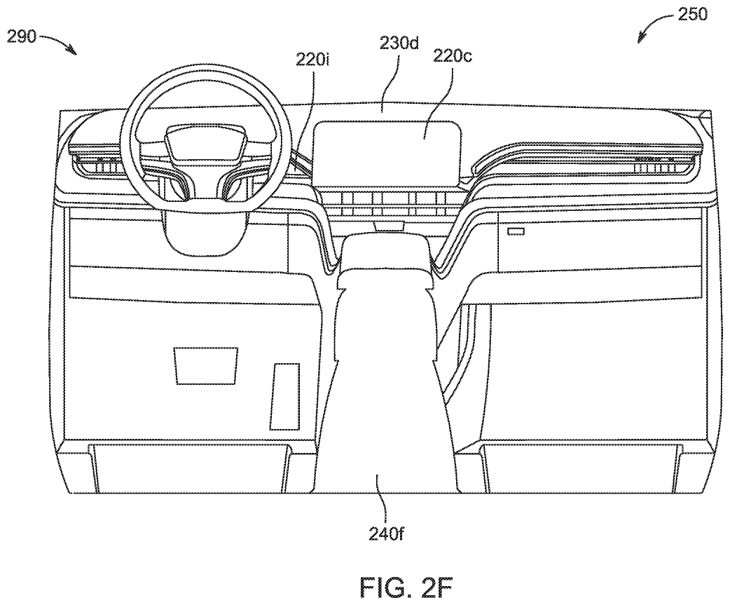

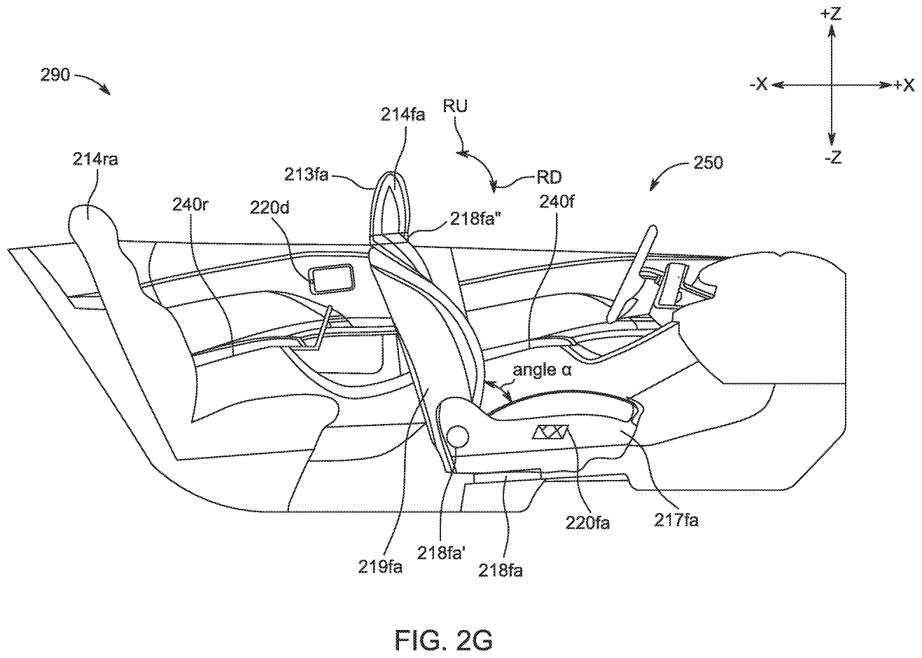

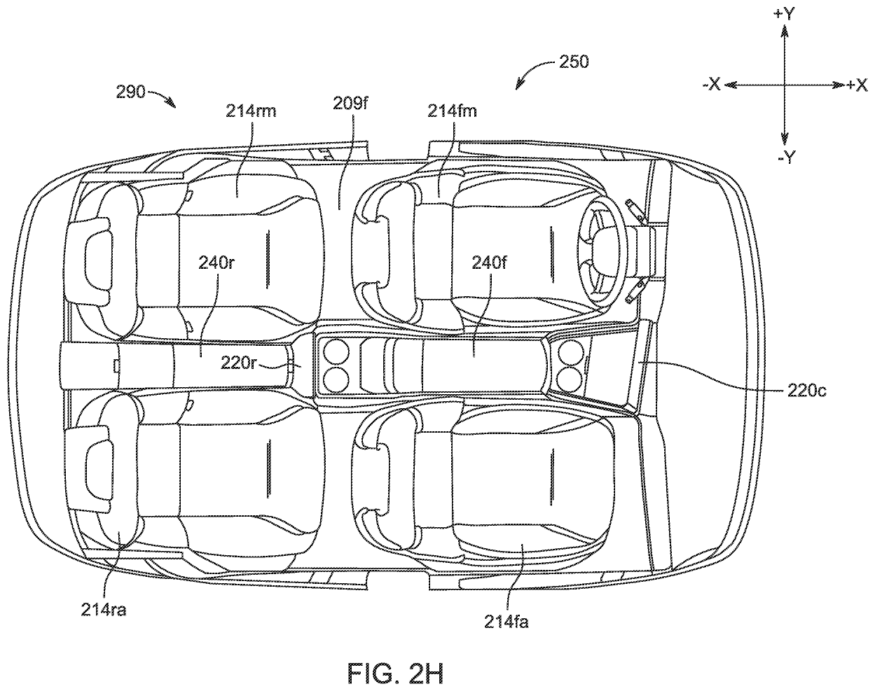

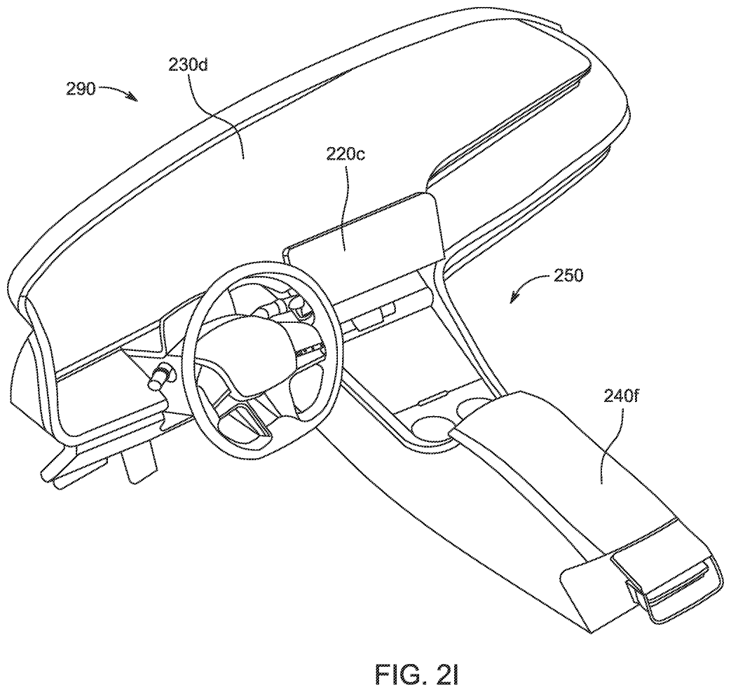

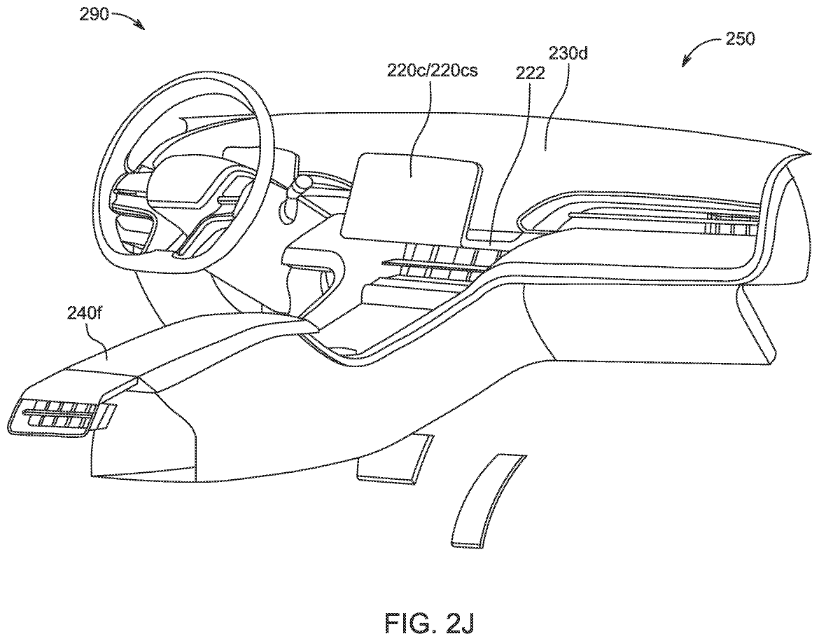

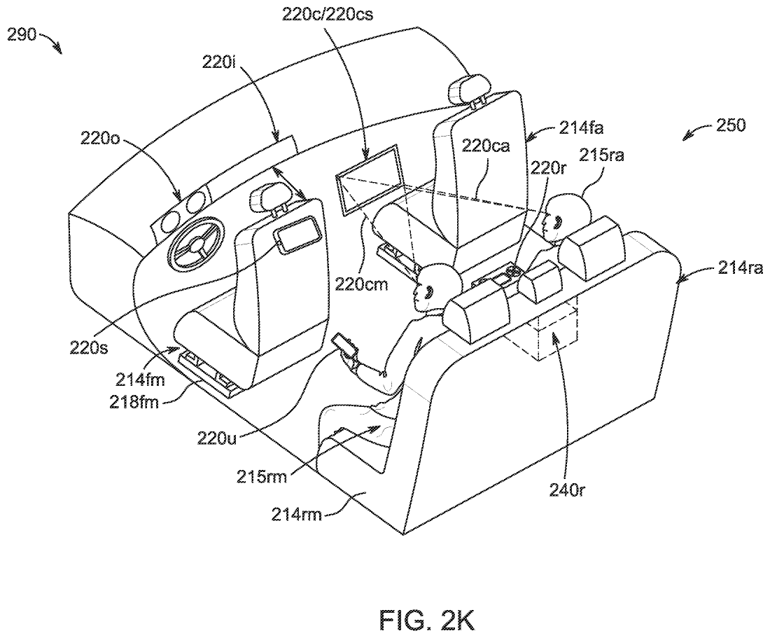

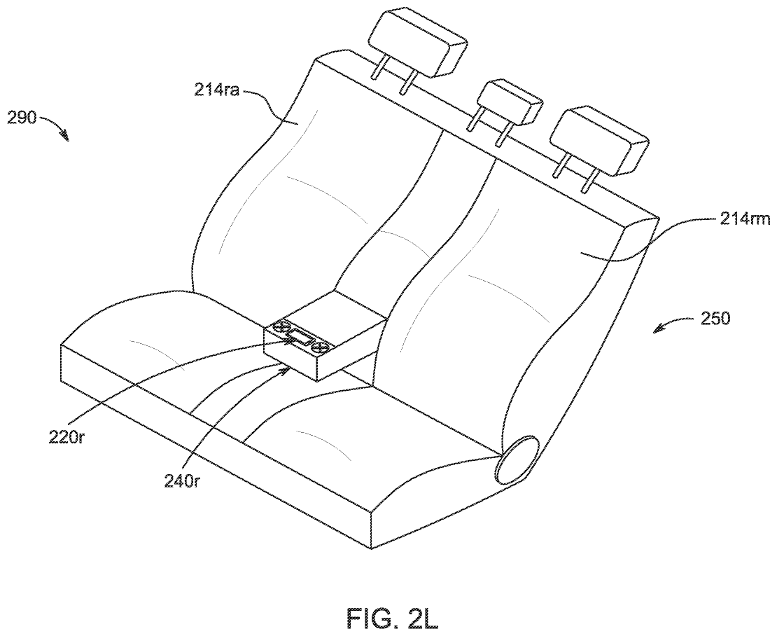

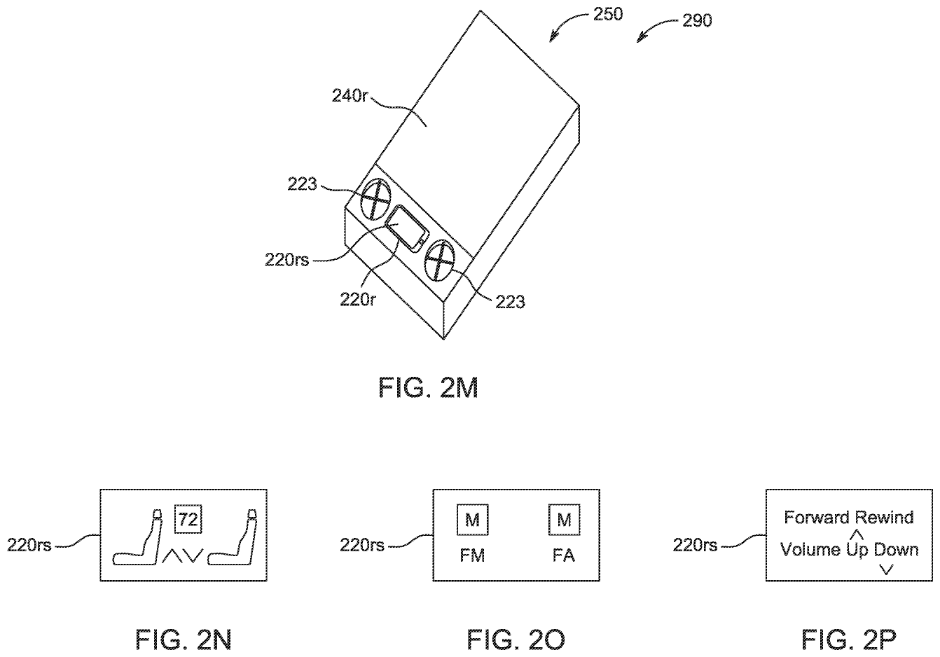

FIGS. 2 and 2A-2P show an illustrative vehicle 290 that may include at least one entity adjustment management system or vehicle seat repositioning management system 250, in accordance with some embodiments of the disclosure. Vehicle 290 may be any suitable vehicle, which may be similar to any vehicle 90 (e.g., vehicles 90a-90c) described herein. As shown, in some embodiments, vehicle 290 may be any suitable automobile with at least one seat, which may include at least a front main seat 214fm (e.g., a driver seat if the vehicle is able to be driven) for a front main passenger (not shown). Additionally, in some embodiments, as shown, vehicle 290 may also include at least one front auxiliary seat 214fa for a front auxiliary passenger (not shown), and at least one rear seat for one or more rear passengers, such as a rear main seat 214rm for a rear main passenger 215rm and/or a rear auxiliary seat 214ra for a rear auxiliary passenger 215ra. Although each seat for each passenger may be distinct in one or more ways from one another (see, e.g., distinct seats 214rm and 214ra of FIGS. 2 and 2A), any vehicle may be provided with a single seat that may be used simultaneously by two or more adjacent passengers (e.g., a bench type rear seat (see, e.g., FIGS. 2K and 2L (e.g., when a rear armrest may be in its upright position))).

Vehicle 290 may include at least one vehicle information subsystem, which may be similar to any subsystem 120, that may be positioned in any suitable position with respect to the vehicle and that may be configured to provide at least one suitable type of user interface (e.g., graphic user interface (“GUI”)) for providing any suitable information to and/or receiving any suitable information from one or more passengers of the vehicle (e.g., a touch screen or any other suitable I/O component(s) that may be coupled (e.g., permanently coupled) to vehicle 290), including, but not limited to, a GUI of an odometer vehicle information subsystem 220o, a GUI of an infotainment vehicle information subsystem 220i, a GUI of a central display vehicle information subsystem 220c, a GUI of a rear seat vehicle information subsystem 220r, seatback vehicle information subsystem 220s, rear door vehicle information subsystem 220d, rear floor vehicle information subsystem 220t, and/or the like. For example, odometer vehicle information subsystem 220o may be provided by or along a portion of a dashboard 230d that may be in front of a front main passenger (e.g., if operating the vehicle) and may be configured to provide any suitable information (e.g., speed information (e.g., rotations per minute (“RPM”) information), odometer information, battery charge level information (e.g., for electric powered vehicles), fuel level information (e.g., for fossil fuel powered vehicles), etc.). As another example, infotainment vehicle information subsystem 220i may be provided by or along another portion of a dashboard 230d that may be in front of a front main passenger (e.g., if operating the vehicle) but also towards a front auxiliary passenger and may be configured to provide any suitable information (e.g., infotainment information (e.g., audio media information, etc.), map information, weather information, time information, etc.). As another example, central display vehicle information subsystem 220c may be provided rear of dashboard 230d towards a front of a front center console 240f that may extend in front of and/or at least partially between front seats 214fm and 214fa, and subsystem 220c may be configured to receive (e.g., from any front or (stretching) rear passenger (e.g., if touch input)) any suitable information (e.g., vehicle seat repositioning control information, movie control information, map control information, etc.) and/or to provide any suitable information (e.g., map information, vehicle seat repositioning control information, theater information or video media information, etc. (e.g., for a vehicle movie theater mode when the vehicle is stationary (e.g., for passengers positioned in the rear seat(s) for a more relaxing experience (e.g., during vehicle charging))) and/or the like) that may be directed towards or otherwise accessible not only to any passenger(s) of front seat(s) 214fm and/or 214fa but additionally or alternatively to any passenger(s) of rear seat(s) 214rm and/or 214ra. For example, as shown in FIG. 2K, a viewing cone 221cm may be made available between a GUI screen 220cs of subsystem 220c and rear main passenger 215rm of rear main seat 214rm and/or a viewing cone 221ca may be made available between GUI screen 220cs of subsystem 220c and rear auxiliary passenger 215ra of rear auxiliary seat 214ra (e.g., to provide a clear view of a GUI of subsystem 220c to one or more rear passengers (e.g., as a screen used for a car movie theater (e.g., for a vehicle movie theater mode when the vehicle is stationary))). As yet another example, rear seat vehicle information subsystem 220r may be provided towards a front of a rear center console 240r that may extend in front of and/or at least partially between rear seats 214rm and 214ra (e.g., as a fixed center console or as a portion of a rear armrest assembly that may be selectively repositioned between an up position for enabling an additional passenger to sit on a bench type middle portion of a rear seat and a down position for providing an armrest feature for rear passengers 215rm and 215ra (e.g., at a free end of which may be provided an I/O component (e.g., touch screen) of subsystem 220r (e.g., between two cup holders 223 (see, e.g., FIG. 2M)))), and subsystem 220r may be configured to provide any suitable information (e.g., rear media information, vehicle seat repositioning control information, etc.) and/or receive (e.g., from a rear passenger) any suitable information (e.g., vehicle seat repositioning control information, etc.). As yet another example, seatback vehicle information subsystem 220s may be provided at least partially in or on or along a back portion (e.g., rearward facing surface) of a front seat (e.g., as shown by FIG. 2K with respect to front seat 214fm) and/or front console 240f and/or the like that may be facing and proximate a passenger of a rear seat (e.g., passenger 215rm and/or passenger 215ra), and subsystem 220s may be configured to provide any suitable information (e.g., rear media information, vehicle seat repositioning control information, etc.) and/or receive (e.g., from a rear passenger) any suitable information (e.g., vehicle seat repositioning control information, etc.). As yet another example, rear door vehicle information subsystem 220d may be provided at least partially in or on or along a portion (e.g., inward facing surface) of a rear passenger door (e.g., as shown by FIGS. 2C and 2G with respect to the vehicle door proximate seat 214rm) that may be facing and proximate a passenger of a rear seat (e.g., passenger 215rm), and subsystem 220d may be configured to provide any suitable information (e.g., rear media information, vehicle seat repositioning control information, etc.) and/or receive (e.g., from a rear passenger) any suitable information (e.g., vehicle seat repositioning control information, etc.). As yet another example, rear floor vehicle information subsystem 220t may be provided at least partially in or on or along a portion (e.g., upward facing surface) of a floor just in front of a rear passenger seat (e.g., as shown by FIGS. 2C and 2E with respect to the vehicle floor proximate seat 214rm) that may be facing and proximate a foot of a passenger of a rear seat (e.g., passenger 215rm), and subsystem 220t may be configured to provide any suitable information (e.g., rear media information, vehicle seat repositioning control information, etc.) and/or receive (e.g., from a rear passenger) any suitable information (e.g., vehicle seat repositioning control information, etc.). Additionally or alternatively, in some embodiments, vehicle 290 may be considered to temporarily include at least one vehicle information subsystem similar to any subsystem 120 that may provide at least one type of user interface (e.g., GUI) for providing any suitable information to one or more passengers of the vehicle (e.g., a screen that may not be permanently coupled to vehicle 290), including, but not limited to, a GUI of a portable user vehicle information subsystem 220u (e.g., a portable media device (e.g., smart phone)) of a user that may be selectively communicatively coupled (e.g., wirelessly (e.g., via Bluetooth) or via any suitable wired connector (e.g., via USB port)) to another (e.g., permanent) subsystem of vehicle 290, where subsystem 220u may be configured to provide any suitable information to a passenger (e.g., speed information, odometer information, vehicle seat repositioning control information, etc.) and/or receive (e.g., from a rear passenger) any suitable information (e.g., vehicle seat repositioning control information, etc.).

Vehicle seat repositioning management system 250 may be provided in any suitable way such that any suitable seat(s) of vehicle 290, such as one, some, or each front seat (e.g., seat 214fm and/or seat 214fa), may be repositioned by a non-passenger of that seat (e.g., automatically or in response to a control from a rear seat passenger) to provide a clearer line of sight between at least one rear seat passenger (e.g., passenger 215rm and/or passenger 215ra) and a user interface of any suitable vehicle information subsystem (e.g., a GUI screen 220cs of central display vehicle information subsystem 220c). For example, as electric vehicles owners may be expected to spend significant time inside the vehicle when the vehicle is charging and not moving, the interior vehicle cabin is envisioned to be used like a living room of a home, whereby one or more occupants may sit comfortably in one or more rear seats and utilize vehicle seat repositioning management system 250 to control the movement of one or more front seats for any suitable reason, such as to clear any obstruction to their sight line(s) for a visual presentation screen (e.g., GUI screen) of a vehicle information subsystem (e.g., screen 220cs of subsystem 220c that may be configured to be operating in a movie mode or other suitable entertainment mode), to create more leg room, and/or the like.

Vehicle seat repositioning management system 250 may include any suitable seat adjusting or repositioning actuator subsystem(s) 218, each of which may include any suitable gears, motors (e.g., linear motors, rotary motors, etc.), and/or other suitable actuators (e.g., soft, hydraulic, pneumatic, thermal, magnetic, etc.) that may be configured to adjust a position or other suitable orientation of a seat of vehicle 290 in one or more ways (e.g., automatically, in response to any suitable control signals (e.g., from any suitable vehicle information subsystem(s) 220)) for enabling any suitable power seat. For example, front seat 214fm may be repositioned in any suitable manner(s) by any suitable actuator(s) of any suitable seat repositioning actuator subsystem(s) 218 of or associated with front seat 214fm, including, but not limited to, actuator 218fm, actuator 218fm′, and/or actuator 218fm″. Actuator 218fm may be any suitable actuator that may be configured to move seat 214fm (e.g., seat base 217fm, seat backrest 219fm, and seat headrest 213fm) in any suitable side to side or front to back or top to bottom or rotation motion and/or the like with respect to floor 209f of vehicle 290 (e.g., towards the right side of the vehicle in the +Y direction, towards the left side of the vehicle in the −Y direction, towards the front of the vehicle in the +X direction, towards the rear of the vehicle in the −X direction, towards the top of the vehicle in the +Z direction, towards the bottom of the vehicle in the −Z direction, about the Z-axis (e.g., with the seat base in an X-Y plane (e.g., such that the seat back rest may be rotated to extend along an interior side wall (e.g., door) of the vehicle)), and/or the like (e.g., the Z-axis may be perpendicular to a surface (e.g., road) supporting the vehicle)). Additionally or alternatively, actuator 218fm″ may be any suitable actuator that may be configured to move seat headrest 213fm of seat 214fm in any suitable side to side or front to back or top to bottom motion or rotation motion about the Y-axis with respect to seat backrest 219fm of seat 214fm (e.g., towards the right side of the vehicle in the +Y direction, towards the left side of the vehicle in the −Y direction, towards the front of the vehicle in the +X direction, towards the rear of the vehicle in the −X direction, towards the top of the vehicle in the +Z direction, towards the bottom of the vehicle in the −Z direction, about the Y-axis so a rear surface of the seat headrest may be positioned parallel or substantially parallel to the ground, about the Z-axis so a rear surface of the seat headrest may be positioned parallel or substantially parallel to a sidewall of the vehicle, and/or the like). Additionally or alternatively, actuator 218fm′ may be any suitable actuator that may be configured to rotate seat backrest 219fm (e.g., along with seat headrest 213fm) of seat 214fm to any suitable angle a (e.g., backrest angle) with respect to seat base 217fm of seat 214fm (e.g., towards the seat base in the direction of arrow RD (e.g., such that a rear surface of seat backrest 219fm may be positioned parallel or substantially parallel to the ground (e.g., such that the rear surface of the backrest may be used as a table or footrest by a passenger in a seat positioned behind this seat)) and/or away from the seat base in the direction of arrow RU (e.g., for enabling a passenger to sit comfortably in this seat)). Similarly, for example, front seat 214fa may be repositioned in any suitable manner(s) by any suitable actuator(s) of any suitable seat repositioning actuator subsystem(s) 218 of or associated with front seat 214fa, including, but not limited to, actuator 218fa, actuator 218fa′, and/or actuator 218fa″. Actuator 218fa may be any suitable actuator that may be configured to move seat 214fa (e.g., seat base 217fa, seat backrest 219fa, and seat headrest 213fa) in any suitable side to side or front to back or top to bottom or rotation motion and/or the like with respect to floor 209f of vehicle 290 (e.g., towards the right side of the vehicle in the +Y direction, towards the left side of the vehicle in the −Y direction, towards the front of the vehicle in the +X direction, towards the rear of the vehicle in the −X direction, towards the top of the vehicle in the +Z direction, towards the bottom of the vehicle in the −Z direction, and/or about the Z-axis (e.g., with the seat base in an X-Y plane (e.g., such that the seat back rest may be extending along an interior side wall (e.g., door) of the vehicle))). Additionally or alternatively, actuator 218fa″ may be any suitable actuator that may be configured to move seat headrest 213fa of seat 214fa in any suitable side to side or front to back or top to bottom motion with respect to seat backrest 219fa of seat 214fa (e.g., towards the right side of the vehicle in the +Y direction, towards the left side of the vehicle in the −Y direction, towards the front of the vehicle in the +X direction, towards the rear of the vehicle in the −X direction, towards the top of the vehicle in the +Z direction, and/or towards the bottom of the vehicle in the −Z direction, about the Y-axis so a rear surface of the seat headrest may be positioned parallel or substantially parallel to the ground, about the Z-axis so a rear surface of the seat headrest may be positioned parallel or substantially parallel to a sidewall of the vehicle, and/or the like). Additionally or alternatively, actuator 218fa′ may be any suitable actuator that may be configured to rotate seat backrest 219fa (e.g., along with seat headrest 213fa) of seat 214fa to any suitable angle a (e.g., backrest angle) with respect to seat base 217fa of seat 214fa (e.g., towards the seat base in the direction of arrow RD (e.g., such that a rear surface of seat backrest 219fa may be positioned parallel or substantially parallel to the ground (e.g., such that the rear surface of the backrest may be used as a table or footrest by a passenger in a seat positioned behind this seat)) and/or away from the seat base in the direction of arrow RU (e.g., for enabling a passenger to sit comfortably in this seat)).

In addition to any suitable seat repositioning actuator subsystem(s) 218, vehicle seat repositioning management system 250 may include any suitable vehicle information subsystem(s) 220, one, some, or each of which may be communicatively coupled to seat repositioning actuator subsystem(s) 218 and operative to receive any suitable input instructions from a user or otherwise (e.g., via any suitable input component and/or sensor) and, in response, generate any suitable output control instruction(s), and then communicate such output control instruction(s) to seat repositioning actuator subsystem(s) 218 for adjusting a position or other suitable orientation of a seat of vehicle 290 in one or more ways (e.g., automatically, in response to any suitable output control instruction(s)). For example, front seat 214fm may be repositioned in any suitable manner(s) by any suitable actuator(s) of any suitable seat repositioning actuator subsystem(s) 218 in response to receiving any suitable output control instruction(s) generated by and transmitted from any suitable vehicle information subsystem(s) 220, including, but not limited to, any suitable subsystems 220 that may be accessible to a passenger seated in front seat 214fm (e.g., odometer vehicle information subsystem 220o, infotainment vehicle information subsystem 220i, central display vehicle information subsystem 220c, and/or a front main seat passenger information subsystem 220fm (e.g., dedicated front main seat passenger controls that may provide any suitable user input component(s) along a side of seat base 217fm of seat 214fm or otherwise that may be easily accessible by a passenger of seat 214fm)), any suitable subsystems 220 that may be accessible to a passenger not seated in front seat 214fm (e.g., passenger 215rm of seat 214rm and/or passenger 215ra of seat 214ra) and/or that may not be accessible to a passenger seated in front seat 214fm (e.g., rear seat vehicle information subsystem 220r, seatback vehicle information subsystem 220s, rear door vehicle information subsystem 220d, rear floor vehicle information subsystem 220t, portable user vehicle information subsystem 220u, and/or the like), and/or the like. Similarly, front seat 214fa may be repositioned in any suitable manner(s) by any suitable actuator(s) of any suitable seat repositioning actuator subsystem(s) 218 in response to receiving any suitable output control instruction(s) generated by and transmitted from any suitable vehicle information subsystem(s) 220, including, but not limited to, any suitable subsystems 220 that may be accessible to a passenger seated in front seat 214fa (e.g., odometer vehicle information subsystem 220o, infotainment vehicle information subsystem 220i, central display vehicle information subsystem 220c, and/or a front auxiliary seat passenger information subsystem 220fa (e.g., dedicated front auxiliary seat passenger controls that may provide any suitable user input component(s) along a side of seat base 217fa of seat 214fa or otherwise that may be easily accessible by a passenger of seat 214fa)), any suitable subsystems 220 that may be accessible to a passenger not seated in front seat 214fa, such as passenger 215rm of seat 214rm and/or passenger 215ra of seat 214ra (e.g., rear seat vehicle information subsystem 220r, seatback vehicle information subsystem 220s, rear door vehicle information subsystem 220d, rear floor vehicle information subsystem 220t, portable user vehicle information subsystem 220u, and/or the like), and/or the like.

In some embodiments, a vehicle seat repositioning management system may be configured to allow or otherwise enable such control of any suitable seat repositioning actuator subsystem(s) 218 by any suitable vehicle information subsystem(s) 220 and/or to control automatically any suitable seat repositioning actuator subsystem(s) 218 only when certain conditions are satisfied (e.g., safety conditions, such as the front seat(s) not being occupied (e.g., as may be determined by an occupation classification system), the vehicle not moving (e.g., as may be determined by a vehicle speedometer), a vehicle door being closed (e.g., as may be determined by a door open/closed status classification system), and/or the like). For example, vehicle seat repositioning management system 250 may include any suitable passenger presence detection subsystem(s) 216, each of which may be communicatively coupled to one or more seat repositioning actuator subsystem(s) 218 and/or one or more vehicle information subsystem(s) 220 of system 250, and a subsystem 216 may be operative to detect (e.g., automatically) an occupancy state of a particular seat of vehicle 290 (e.g., an occupancy state or a vacancy state, such as whether or not a passenger is currently sitting in a particular seat of vehicle 290 (e.g., via any suitable input component and/or sensor (e.g., weight sensor, camera sensor, etc.) and/or processing (e.g., occupant classification application processing, etc.))) and, in response, may be operative to generate (e.g., automatically) any suitable output control instruction(s), and then may be operative to communicate (e.g., automatically) such output control instruction(s) for selectively enabling a seat repositioning actuator subsystem 218 to be controlled by a vehicle information subsystem 220 of vehicle seat repositioning management system 250 (e.g., allow or disallow user control via subsystem 220 based on whether or not a passenger is detected in one or more seats) and/or for automatically controlling a seat repositioning actuator subsystem 218 (e.g., based on any suitable programmed settings (e.g., of an application 19), such as move a front seat as far front as possible when no passenger is detected in the seat and a vehicle door associated with the seat is determined to be closed, whereby no active user control via a subsystem 220 may be utilized for such a repositioning). As shown, seat 214fm may include any suitable passenger presence detection subsystem 216fm that may be operative to detect whether or not a passenger is occupying seat 214fm, seat 214fa may include any suitable passenger presence detection subsystem 216fa that may be operative to detect whether or not a passenger is occupying seat 214fa, seat 214rm may include any suitable passenger presence detection subsystem 216ra that may be operative to detect whether or not a passenger is occupying seat 214ra, and/or seat 214rm may include any suitable passenger presence detection subsystem 216rm that may be operative to detect whether or not a passenger is occupying seat 214rm. Vehicle seat repositioning management system 250 may be configured (e.g., using any suitable application(s) and/or any suitable processor(s) of any suitable subsystem(s) (e.g., subsystem(s) 216, 218, and/or 220)) to allow (e.g., automatically or via rear seat user control) seat repositioning of a front seat (e.g., seat 214fm and/or seat 214fa) only (i) if that front seat is determined not to be occupied (e.g., such that a rear seat passenger may not use system 250 to reposition a seat occupied by another passenger) and/or (ii) if a rear seat is determined to be occupied (e.g., such that a front seat may not be repositioned by system 250 to facilitate a movie theater mode if a rear seat is not occupied by a passenger that would benefit from such a movie theater mode) (in some embodiments, only one of these two conditions may be required for a particular programmed seat repositioning (e.g., only (i)).

Additionally or alternatively, in some embodiments, a vehicle seat repositioning management system may be configured to allow such control of any suitable seat repositioning actuator subsystem(s) 218 by any suitable vehicle information subsystem(s) 220 and/or to control automatically any suitable seat repositioning actuator subsystem(s) 218 when certain conditions other than or in addition to seat occupation condition(s) are satisfied (e.g., safety conditions, such as the vehicle not moving (e.g., as may be determined by a vehicle speedometer), a vehicle door being closed (e.g., as may be determined by any suitable vehicle sensor(s)), and/or the like). For example, vehicle seat repositioning management system 250 may include any suitable vehicle movement detection subsystem(s) 211, each of which may be communicatively coupled to one or more seat repositioning actuator subsystem(s) 218 and/or one or more vehicle information subsystem(s) 220 of system 250 and each subsystem 211 may be operative to detect (e.g., automatically) whether or not vehicle 290 is being operated in a particular manner (e.g., via any suitable input component and/or sensor (e.g., odometer, accelerometer, camera sensor, door sensor, etc.) and/or processing) and, in response, may be operative to generate (e.g., automatically) any suitable output control instruction(s), and then may be operative to communicate (e.g., automatically) such output control instruction(s) for selectively enabling a seat repositioning actuator subsystem 218 to be controlled automatically and/or for selectively enabling a seat repositioning actuator subsystem 218 to be controlled by a vehicle information subsystem 220 of vehicle seat repositioning management system 250 (e.g., allow or disallow control based on whether or not the vehicle is moving (e.g., driving above 5 miles per hour, parked, idle, etc.), whether or not a passenger door of the vehicle is open or closed, and/or the like). Vehicle seat repositioning management system 250 may be configured (e.g., using any suitable application(s) and/or any suitable processor(s) of any suitable subsystem(s) (e.g., subsystem(s) 211, 216, 218, and/or 220)) to allow (e.g., automatically or via rear seat user control) seat repositioning of a front seat (e.g., seat 214fm and/or seat 214fa) only (i) if that front seat is determined not to be occupied (e.g., such that a rear seat passenger may not use system 250 to reposition a seat occupied by another passenger), (ii) if a rear seat is determined to be occupied (e.g., such that a front seat may not be repositioned by system 250 to facilitate a movie theater mode if a rear seat is not occupied by a passenger that would benefit from such a movie theater mode), (iii) if the vehicle is determined not to be moving more than a certain threshold amount if at all (e.g., to prevent dangerous seat repositioning while the vehicle is being used to travel), and/or (iv) if the door associated with providing passenger entry to that front seat (e.g., a front main seat door 214dfm associated with access to front main seat 214fm, a front auxiliary seat door 214dfa associated with access to front auxiliary seat 214fa, etc.) is determined not to be open (e.g., to prevent dangerous seat repositioning of a front seat while a person may be attempting to occupy that front seat via an open door associated with that front seat) (in some embodiments, only one or two or three of these four conditions may be required for a particular programmed seat repositioning (e.g., only (i) and (iv)).

A vehicle information subsystem 220 of vehicle seat repositioning management system 250 that may be used to receive instructions (e.g., user instructions) for repositioning a seat (e.g., move the entirety of front main seat further towards the front of the vehicle, move the head rest of the front auxiliary seat further towards the front auxiliary door, rotate the back rest of each front seat down to provide tables for the rear passengers, etc.) may include any suitable user interface (e.g., I/O component(s)) operative to receive such instructions (e.g., touch screen, physical button(s), physical slider(s), microphone(s) for detecting audible voice activated commands, motion sensors and/or light sensors and/or the like for detecting waving or other suitable physical gestures in space, and/or the like).

In some embodiments, system 250 may be configured to reposition a vehicle seat automatically in response to detecting certain conditions. For example, system 250 may be configured to move a front seat automatically from a first position (e.g., a position that may be comfortable for a passenger to sit in while the vehicle is traveling) to a second position (e.g., a forward position and/or a rotated down position and/or otherwise that may be better for a movie theater mode and/or otherwise for a passenger sitting behind the front seat) in response to one or more particular conditions being detected, such as in response to determining (i) that no passenger is detected in the front seat to be moved, (ii) that a passenger is detected in a seat behind the front seat to be moved (e.g., passenger 215rm in seat 214rm and/or passenger 215ra in seat 214ra when seat 214fm and/or seat 214fa is to be moved), (iii) that the vehicle is not moving, and/or (iv) that the door associated with providing passenger entry to that front seat is not open (in some embodiments, only one or two or three of these four conditions may be required for a particular programmed seat repositioning (e.g., only (i) and (iv)). The second position to which the seat may be automatically moved may be a predefined position (e.g., customizable by a user or by a manufacturer or manager of the system) that may be desirable for providing the passenger with comfort and/or unobstructed viewing of an I/O component (e.g., condition(s) and/or repositioning position(s) may be predefined in any suitable application 19 that may be executed for automatic seat repositioning when certain condition(s) are determined to be satisfied). For example, one or more feet or legs of a rear passenger may be detected by any suitable sensor of any suitable sensing subsystem 211 or 220 (e.g., subsystem 220t) in order to satisfy at least one of the conditions that may allow automatic repositioning of a front seat (e.g., to automatically provide additional comfort to the rear passenger (e.g., to provide additional leg room) without requiring the rear passenger to actively provide instructions to reposition the front seat).

In some embodiments, system 250 may be configured to move (e.g., adjust the position and/or orientation of) any suitable vehicle subsystem I/O component in addition to or as an alternative to moving (e.g., adjusting the position and/or orientation) of any suitable vehicle seat. For example, in response to detecting any suitable user instructions (e.g., via rear seat vehicle information subsystem 220r, seatback vehicle information subsystem 220s, rear door vehicle information subsystem 220d, rear floor vehicle information subsystem 220t, portable user vehicle information subsystem 220u, and/or the like) and/or in response to determining the satisfaction of any suitable conditions (e.g., presence of rear seat passenger, lack of presence of front seat passenger, lack of vehicle movement, and/or the like), system 250, in addition to or as an alternative to repositioning a vehicle seat (e.g., adjusting the position and/or orientation of a vehicle seat), may be configured to reposition (e.g., automatically or via rear seat user control) a vehicle subsystem I/O component (e.g., screen 220cs of subsystem 220c) using any suitable I/O component adjusting or repositioning actuator subsystem(s) 222 (e.g., for adjusting the position and/or orientation and/or any other suitable characteristic (e.g., output characteristic (e.g., brightness, volume, on/off characteristic, media playback characteristic, etc.)) of an I/O component), each of which may include any suitable gears, motors (e.g., linear motors, rotary motors, etc.), and/or other suitable actuators (e.g., soft, hydraulic, pneumatic, thermal, magnetic, etc.) that may be configured to adjust a position or orientation or otherwise (e.g., brightness, volume, etc.) of a vehicle subsystem I/O component (e.g., screen 220cs of subsystem 220c) and/or to move a seat in one or more ways (e.g., automatically, in response to any suitable control signals (e.g., from any suitable vehicle information subsystem(s) 220)). This may enable a passenger or the system (e.g., automatically) to reposition a location (e.g., X, Y, Z) and/or orientation (e.g., tilt or rotation about any suitable axis (e.g., for changing between portrait and landscape orientations)) and/or brightness and/or any other suitable characteristic of a screen or I/O component based on a particular scenario (e.g., a front seat passenger operating the vehicle while viewing a map on the screen vs. no front seat passenger but a back seat passenger watching entertainment media on the screen).

As shown in FIG. 2M, one specific example of subsystem 220r may be an electronic device, such as a smart phone type device, which may include a touch screen I/O component 220rs (e.g., an output component may be a display that can be used to display a visual or graphic user interface (“GUI”), which may allow a user to interact with subsystem 220r). A screen of the GUI of I/O component 220rs may include various layers, windows, screens, templates, elements, menus, and/or other components of a currently running application (e.g., vehicle seat repositioning management application) that may be displayed in all or some of the areas of the display output component. One or more of any suitable user input components of the subsystem may be used to navigate through the GUI (e.g., a scroll wheel that may allow a user to select one or more graphical elements or icons of the GUI, and/or icons of the GUI may be selected via a touch screen I/O component, where such a touch screen I/O component may employ any suitable type of touch screen input technology, such as, but not limited to, resistive, capacitive, infrared, surface acoustic wave, electromagnetic, or near field imaging, and/or may employ single point or multi-point (e.g., multi-touch) input sensing).

The GUI icons may represent various applications, layers, windows, screens, templates, elements, and/or other components that may be displayed in some or all of the areas of a display component of the subsystem upon selection by the user. Furthermore, selection of a specific icon may lead to a hierarchical navigation process. For example, selection of a specific icon may lead from one screen to screen to a new screen of the GUI that may include one or more additional icons or other GUI elements of the same application or of a new application associated with that icon. Textual indicators may be displayed on or near one, some, or each icon to facilitate user interpretation of the graphical element icon. It is to be appreciated that a GUI may include various components arranged in hierarchical and/or non-hierarchical structures. When a specific icon is selected, the subsystem may be configured to open a new application associated with that icon and display a corresponding screen of the GUI associated with that application (see, e.g., FIGS. 2N-2P for specific examples of such displays of a GUI during use of any suitable vehicle seat repositioning management application that may be used by a user for selectively repositioning one or more components of one or more seats of the vehicle). For each application, screens may be displayed on a display output component of the subsystem and may include various user interface elements. Additionally or alternatively, for each application, various other types of non-visual information may be provided to a user via various other output components of the subsystem (e.g., audible, tactile, etc.).

As just one example, as shown in FIG. 2N, screen 220rs may provide a GUI that shows icons indicative of front seats 214fm and 214fa that may be utilized for repositioning those seats in any suitable particular way(s), as well as temperature controls that may be operative to adjust cabin temperature, which may be useful for a rear seat passenger desiring to watch content on screen 220cs of subsystem 220c in a comfortable environment. As another example, as shown in FIG. 2O, screen 220rs may provide a GUI that shows icons indicative of one or more particular seat repositionings for a particular mode (e.g., movie theater mode), such as a radio button “M” for seat FM, which, when selected, may move seat 214fm as forward and as to the side as possible while rotating the back rest down for providing a table or otherwise moving the seat out of the way of cones 220cm and/or 220ca as possible (e.g., to provide a clear view of screen 220cs of subsystem 220c for rear seat passenger(s)), and/or a similar radio button for seat 214fa, which may be useful for a rear seat passenger desiring to watch content on screen 220cs of subsystem 220c. As another example, as shown in FIG. 2P, screen 220rs may provide a GUI that shows icons indicative of one or more particular movie media controls (e.g., fast forward, rewind, volume up, volume down, etc.), which may be useful for a rear seat passenger watching content on screen 220cs of subsystem 220c.

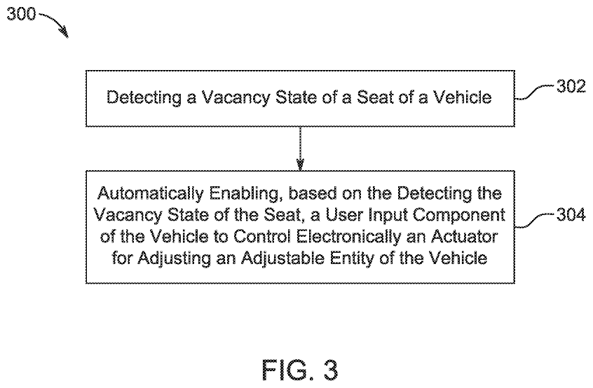

FIG. 3 is a flowchart of an illustrative process 300 for using a vehicle. At operation 302 of process 300, a vacancy state of a seat of the vehicle may be detected (e.g., passenger presence detection subsystem 216fm may detect that no passenger is occupying seat 214fm). Then, at operation 304 of process 300, a user input component of a vehicle information subsystem of the vehicle may be automatically enabled, based on the detected vacancy state of the seat, to control electronically an actuator for adjusting an adjustable entity of the vehicle (e.g., a user input component of any suitable vehicle information subsystem (e.g., subsystem 220r, 220d, 220t, 220s, etc. (e.g., a vehicle information subsystem that may be accessible to a passenger not seated in seat 214fm and/or that may not be accessible to a passenger seated in seat 214fm)) may be automatically enabled to control (e.g., to allow a user to control) an actuator for adjusting seat 214fm or a display screen output component of another vehicle information subsystem (e.g., subsystem 220c), such as to adjust electronically the position or orientation or an output characteristic of a display output component or to adjust electronically the position or orientation of a front seat).

The operations shown in process 300 of FIG. 3 are only illustrative and existing operations may be modified or omitted, additional operations may be added, and the order of certain operations may be altered.

One, some, or all of the processes described with respect to FIGS. 1-3 may each be implemented by software, but may also be implemented in hardware, firmware, or any combination of software, hardware, and firmware. Instructions for performing these processes may also be embodied as machine-or computer-readable code recorded on a machine-or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 of a subsystem). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one subsystem to another directly or via any suitable network or bus or the like. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

As used in this specification and any claims of this application, the terms “base station,” “receiver,” “computer,” “server,” “processor,” and “memory” may all refer to electronic or other technological devices. These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein may refer to and encompass any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items. and/or at least one of any combination of the items, and/or at least one of each of the items. By way of example, the phrases “at least one of A, B. and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

The term “if” may, optionally, be construed to mean “when” or “upon” or “in response to determining” or “in response to detecting,” depending on the context. Similarly, the phrase “if it is determined” or “if [a stated condition or event] is detected” may, optionally, be construed to mean “upon determining” or “in response to determining” or “upon detecting [the stated condition or event]” or “in response to detecting [the stated condition or event],” depending on the context.

As used herein, the terms “computer,” “personal computer,” “device,” “computing device,” “router device,” and “controller device” may refer to any programmable computer system that is known or that will be developed in the future. In certain embodiments, a computer may be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As used herein, the terms “component,” “module,” and “system” may be intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description of the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

While there have been described systems, methods, and computer-readable media for repositioning vehicle seats, many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

What is claimed is:

1. A vehicle comprising:
a seat;
an adjustable vehicle entity; and
an entity adjustment management system comprising:
a passenger presence detection subsystem operative to determine an occupancy state of the seat;
a vehicle information subsystem comprising a user input component; and
an entity adjusting actuator subsystem operative to adjust the adjustable vehicle entity, wherein the entity adjustment management system is configured to enable automatically, based on the passenger presence detection subsystem determining that the seat is vacant, the user input component of the vehicle information subsystem to control electronically the entity adjusting actuator subsystem to adjust the adjustable vehicle entity.

2. The vehicle of claim 1, wherein the adjustable vehicle entity is the seat.

3. The vehicle of claim 2, wherein the entity adjusting actuator subsystem is operative to adjust a position or orientation of the seat.

4. The vehicle of claim 1, wherein:
the vehicle further comprises another vehicle information subsystem comprising an output component; and
the adjustable vehicle entity is the other vehicle information subsystem.

5. The vehicle of claim 4, wherein the entity adjusting actuator subsystem is operative to adjust a position or orientation or output characteristic of the output component.

6. The vehicle of claim 1, wherein:
the vehicle further comprises another seat; and
the user input component of the vehicle information subsystem is accessible to a passenger seated in the other seat.

7. The vehicle of claim 1, wherein:
the vehicle further comprises another seat; and
the user input component of the vehicle information subsystem is not accessible to a passenger seated in the seat.

8. The vehicle of claim 1, wherein:
the vehicle further comprises another seat; and
the user input component of the vehicle information subsystem is provided by one of the following:
a back of the seat;
an armrest of the other seat;
a door of the vehicle that is operative to provide passenger access to the other seat; or
a portion of a floor of the vehicle that is in front of the other seat.

9. The vehicle of claim 1, wherein:
the vehicle further comprises another seat;
the entity adjustment management system further comprises another passenger presence detection subsystem operative to determine an occupancy state of the other seat; and
the entity adjustment management system is configured to enable automatically, based on the passenger presence detection subsystem determining that the seat is vacant and based on the other passenger presence detection subsystem determining that the other seat is occupied, the vehicle information subsystem to control electronically the entity adjusting actuator subsystem to adjust the adjustable vehicle entity.

10. The vehicle of claim 9, wherein:
the adjustable vehicle entity is the seat; and
the entity adjusting actuator subsystem is operative to adjust a position or orientation of the seat.

11. The vehicle of claim 9, wherein:
the vehicle further comprises another vehicle information subsystem comprising an output component;
the adjustable vehicle entity is the other vehicle information subsystem; and
the entity adjusting actuator subsystem is operative to adjust a position or orientation or output characteristic of the output component.

12. The vehicle of claim 1, wherein:
the vehicle further comprises a door that is operative to provide passenger access to the seat;
the entity adjustment management system further comprises a door detection subsystem operative to determine an open/closed state of the door; and
the entity adjustment management system is configured to enable automatically, based on the passenger presence detection subsystem determining that the seat is vacant and based on the door detection subsystem determining that the door is closed, the vehicle information subsystem to control electronically the entity adjusting actuator subsystem to adjust the adjustable vehicle entity.

13. The vehicle of claim 1, wherein:
the vehicle further comprises:
another seat; and
a door that is operative to provide passenger access to the seat;
the entity adjustment management system further comprises:
another passenger presence detection subsystem operative to determine an occupancy state of the other seat; and
a door detection subsystem operative to determine an open/closed state of the door; and
the entity adjustment management system is configured to enable automatically, based on the passenger presence detection subsystem determining that the seat is vacant and based on the other passenger presence detection subsystem determining that the other seat is occupied and based on the door detection subsystem determining that the door is closed, the vehicle information subsystem to control electronically the entity adjusting actuator subsystem to adjust the adjustable vehicle entity.

14. The vehicle of claim 1, wherein:
the vehicle further comprises a speedometer operative to determine a speed of the vehicle; and
the entity adjustment management system is configured to enable automatically, based on the passenger presence detection subsystem determining that the seat is vacant and based on the speedometer determining that the speed of the vehicle is less than a particular speed, the vehicle information subsystem to control electronically the entity adjusting actuator subsystem to adjust the adjustable vehicle entity.

15. The vehicle of claim 1, wherein:
the vehicle further comprises:
another seat; and
a speedometer operative to determine a speed of the vehicle;
the entity adjustment management system further comprises another passenger presence detection subsystem operative to determine an occupancy state of the other seat; and
the entity adjustment management system is configured to enable automatically, based on the passenger presence detection subsystem determining that the seat is vacant and based on the other passenger presence detection subsystem determining that the other seat is occupied and based on the speedometer determining that the speed of the vehicle is less than a particular speed, the vehicle information subsystem to control electronically the entity adjusting actuator subsystem to adjust the adjustable vehicle entity.

16. The vehicle of claim 1, wherein:
the adjustable vehicle entity is the seat;
the vehicle further comprises:
another vehicle information subsystem comprising an output component; and
another entity adjusting actuator subsystem operative to adjust the output component; and
the entity adjustment management system is further configured to enable automatically, based on the passenger presence detection subsystem determining that the seat is vacant, the vehicle information subsystem to control electronically the other entity adjusting actuator subsystem to adjust the output component of the other vehicle information subsystem.

17. The vehicle of claim 1, wherein:
the adjustable vehicle entity is the seat; and
the entity adjusting actuator subsystem is operative to adjust the adjustable vehicle entity by rotating a backrest of the seat with respect to a seat base of the seat.

18. The vehicle of claim 1, wherein:
the vehicle further comprises a display screen output component;
the adjustable vehicle entity is the display screen output component; and
the entity adjusting actuator subsystem is operative to adjust the adjustable vehicle entity by rotating the display screen output component from a portrait orientation to a landscape orientation.

19. A method for using a vehicle, the method comprising:
detecting a vacancy state of a seat of the vehicle; and
automatically enabling, based on the detecting the vacancy state of the seat, a user input component of a vehicle information subsystem of the vehicle to control electronically an actuator for adjusting an adjustable entity of the vehicle.

20. A non-transitory computer-readable storage medium storing at least one program, the at least one program comprising instructions, which, when executed by at least one processor of an entity adjustment management system of a vehicle comprising a seat and an adjustable vehicle entity and a user input component, cause the at least one processor to:
detect a vacancy state of the seat of the vehicle; and
in response to detection of the vacancy state, automatically enable the user input component to adjust electronically the adjustable vehicle entity.
